(19) United States
(12) Patent Application Publication
(10) Pub. No.: US 2013/0172447 A1
(43) Pub. Date: Jul. 4, 2013

(54) PHOSPHOROUS FLAME RETARDANT INCLUDING NSP

(71) Applicants: Jiang-Jen Lin, Taipei (TW); Ying-Nan Chan, Taipei (TW); Jau-Yu Chiou, Taipei (TW)

(72) Inventors: Jiang-Jen Lin, Taipei (TW); Ying-Nan Chan, Taipei (TW); Jau-Yu Chiou, Taipei (TW)

(73) Assignee: NATIONAL TAIWAN UNIVERSITY, Taipei (TW)

(21) Appl. No.: 13/561,072

(22) Filed: Jul. 29, 2012

(30) Foreign Application Priority Data
Dec. 30, 2011 (TW) 100150019

(51) Int. Cl. C09K 21/12; C08K 3/36; C08L 63/02; B82Y 30/00

(52) U.S. Cl. 523/466; 252/609; 977/775

(57) ABSTRACT

A phosphorous flame retardant including nanosilicate platelets (NSP) is made by first reacting hexachlorotriphosphazene (HCP) with poly(oxyalkylene)amine, then mixing the HCP product with nano silicate platelets (NSP) to obtain the phosphorous flame retardant including NSP. The phosphorous flame retardant can be further applied to an epoxy resin as a curing agent.

### BACKGROUND OF THE INVENTION

1. Field of the Invention

The present invention relates to a phosphorous flame retardant including NSP and a method for producing the same. This flame retardant can be applied to electrical devices such as printed circuit boards (PCB), packaging materials of semiconductors or other flame retardant articles.

2. Related Prior Arts

In order to modify polymers to have flame retardant property, additives are usually added. The additives can be inorganic and organic. The inorganic additives include metal oxides and hydroxides, and the organic additives primarily contain halogen. However, the flame retardants containing halogen will generate corrosive or toxic gas and thus are gradually replaced by phosphorous flame retardants.

The phosphorous flame retardant can induce polymers to dewater during burning so that the temperature is reduced. Meanwhile, the phosphorous acid generated can carbonize polymers to form an inflammable protective surface. In addition, the phosphorous acid can further dewater polymers to form a glass-like-melt cover to prevent oxygen from contacting and volatile objects from releasing. Due to its advantages of low toxicity, good processing ability, less smoke and good capacity with epoxy, the phosphorous flame retardants are becoming more significant. Generally, the phosphorous chemicals include reactive groups such as hydroxide group (—OH) and amino group (—NH₂) and can further synthesize with thermosetting or thermoplastic polymers.

To improve the effect of flame retardants, inorganic clay can be added. However, the natural clay is hydrophilic and in the form of stacked layers, it's therefore difficult for the natural clay to be complexed with organic molecules.

The present invention provides a method to produce a phosphorous flame retardant including nanosilicate platelets (NSP) to overcome the aforementioned disadvantages.

### SUMMARY OF THE INVENTION

An object of the present invention is to provide a phosphorous flame retardant including nanosilicate platelets (NSP) and a method for producing the same. The method is simple and the produced flame retardant exhibits good flame retardant property.

Another object of the present invention is to provide a resin including the above flame retardant and a method for producing the same so that the flame retardant property and strength of the resin can be improved.

The method for producing the phosphorous NSP flame retardant primarily includes the steps of:
(a) mixing hexachlorocyclotriphosphazene (HCP), alkaline and poly(oxyalkylene)amine in a first solvent to perform replacement reaction so that at least one chlorine of HCP is replaced with poly(oxyalkylene)amine and HCP-poly(oxyalkylene)amine is produced, wherein the poly(oxyalkylene)amine includes at least two end amino groups (—NH₂), the molar ratio of HCP to poly(oxyalkylene)amine ranges from 1/1 to 1/12, and the reaction temperature ranges from 35° C. to 85° C., preferably 40° C. to 70° C., and more preferably 45° C. to 60° C. The first solvent is preferably removed after the replacement reaction;
(b) mixing HCP-poly(oxyalkylene)amine of step (a) and nanosilicate platelets (NSP) in a second solvent and the HCP-poly(oxyalkylene)amine/NSP flame retardant is produced, wherein the NSP is in the form of individual platelets or layers exfoliated from layered clay and the weight ratio of HCP-poly(oxyalkylene)amine to NSP ranges from 1/20 to 10/1, and preferably 1/12 to 3/1.

Preferably, the poly(oxyalkylene)amine of step (a) is previously mixed with the first solvent, then the HCP dissolved in the first solvent is slowly dropped thereinto, and finally the alkaline is slowly dropped thereinto. The first solvent is preferably tetrahydrofuran (THF). Poly(oxyalkylene)amine of the step (a) is preferably poly(oxyalkylene)diamine having a molecular weight from 200 to 2,500. The alkaline can be triethylamine, pyridine or sodium hydroxide. The second solvent of step (b) can be alcohol or aldehyde. The nanosilicate platelets of step (b) are preferably in a water solution of 1 to 30 wt %.

The method can further include step (c):
(c) crosslinking HCP-poly(oxyalkylene)amine/NSP flame retardant of step (b) with epoxy to produce a flame retardant resin of HCP-poly(oxyalkylene)amine/NSP/epoxy, wherein HCP-poly(oxyalkylene)amine/NSP in the reaction mixture is present in an amount of 0.1 to 50 wt % and the crosslinking reaction temperature ranges from 10 to 200° C., and preferably for the temperature to be gradually raised from 10° C. to 150° C.

In step (c), epoxy can be DGEBA, and HCP-poly(oxyalkylene)amine/NSP in the reaction mixture is preferably present in an amount of 0.2 to 20 wt %, more preferably 0.5 to 15, and most preferably 1.0 to 10.

The phosphorous NSP flame retardant produced by the above method therefore includes HCP-poly(oxyalkylene)amine and nanosilicate platelets (NSP); wherein HCP-poly(oxyalkylene)amine is mixed with NSP in a weight ratio of 1/20 to 10/1, and the molar ratio of HCP to poly(oxyalkylene)amine is 1/1 to 1/12. HCP-poly(oxyalkylene)amine, poly(oxyalkylene)amine and NSP are defined above.

A flame retardant resin including the phosphorous NSP flame retardant can be produced by reacting with epoxy. In the reaction, the end amino groups (—NH₂) of poly(oxyalkylene)amine crosslink with epoxy, and the phosphorous NSP flame retardant is present in an amount of 0.1 to 50 wt % in the flame retardant resin.

HCP-poly(oxyalkylene)amine and NSP can be mixed in different ratios to achieve various flame retardant effect and then HCP-poly(oxyalkylene)amine/NSP is reacted with epoxy to produce cured resin of different degrees in crosslinking. The improved epoxy can be further used in electrical devices.

### BRIEF DESCRIPTION OF THE DRAWINGS

FIG. 1 shows the synthetic reaction of HCP and poly(oxyalkylene)amine.

FIG. 2 shows char yields of thermal pyrolysis of HCP-D400/NSP/DGEBA and HCP-D400/MMT/DGEBA.

### DETAILED DESCRIPTION OF THE PREFERRED EMBODIMENTS

In the present invention, main materials used in Examples and Comparative Examples include:
(a) HCP: hexachlorocyclotriphosphazene (HCP), Mw=347.6 g/mole, merchandized from Kuo Ching Chemical Co., Ltd.
(b) Nanosilicate Platelet (NSP): in the form of individual platelets or layers exfoliated from layered clay such as Na⁺-montmorillonite (Na⁻-MMT) or mica; merchandized from JJ Nano Technology Co., Ltd. (10 wt % in water); CEC=1.2 meq/g, aspect ratio about 80×80×1 to 120×120×1 nm³ with an average of about 100×100×1 nm³; surface area about 700 to 800 m²/g; ionic charge density about 18,000 to 20,000 ions/platelet; about 4×10¹⁶ platelets/g; isoelectric point (IEP) in water at pH=6.4; rearranging when dispersed in a solution, for example, with dual layers or platelets as a structural unit.
(c) triethylamine: triethylamine (TEA), Mw=101 g/mole, merchandized from Adrich; used for removing hydrochloric acid generated during a reaction; organic alkaline pyridine or inorganic alkaline NaOH are also suitable.
(d) poly(oxyalkylene)amine: poly(oxypropylene)-amines, merchandized from Hunstsman Chemical Co.; trademark JEFFAMINE® D-amine series; and having structural formula as follows:

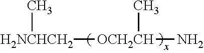

D230 (x=2 to 3); Mw to 230 g/mole;
D400 (x=5 to 6); Mw to 400 g/mole;
D2000 (x=33); Mw to 2000 g/mole.

(e) Diglycidyl ether of bisphenol A (DGEBA): merchandized from Nan Ya Plastics Co.; type: BE188; M_{w}=350; epoxy equivalent weight (EEW)=188; and having structural formula as follows:

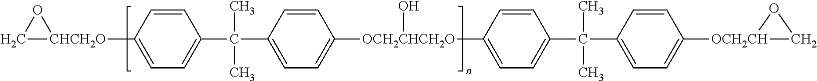

The detailed procedures for producing the flame retardant of the present invention are described as follow.

### Example 1

### Step (a) Synthesizing the Phosphazene-Poly(Oxyalkylene)Amine Adduct (HCP-D400)

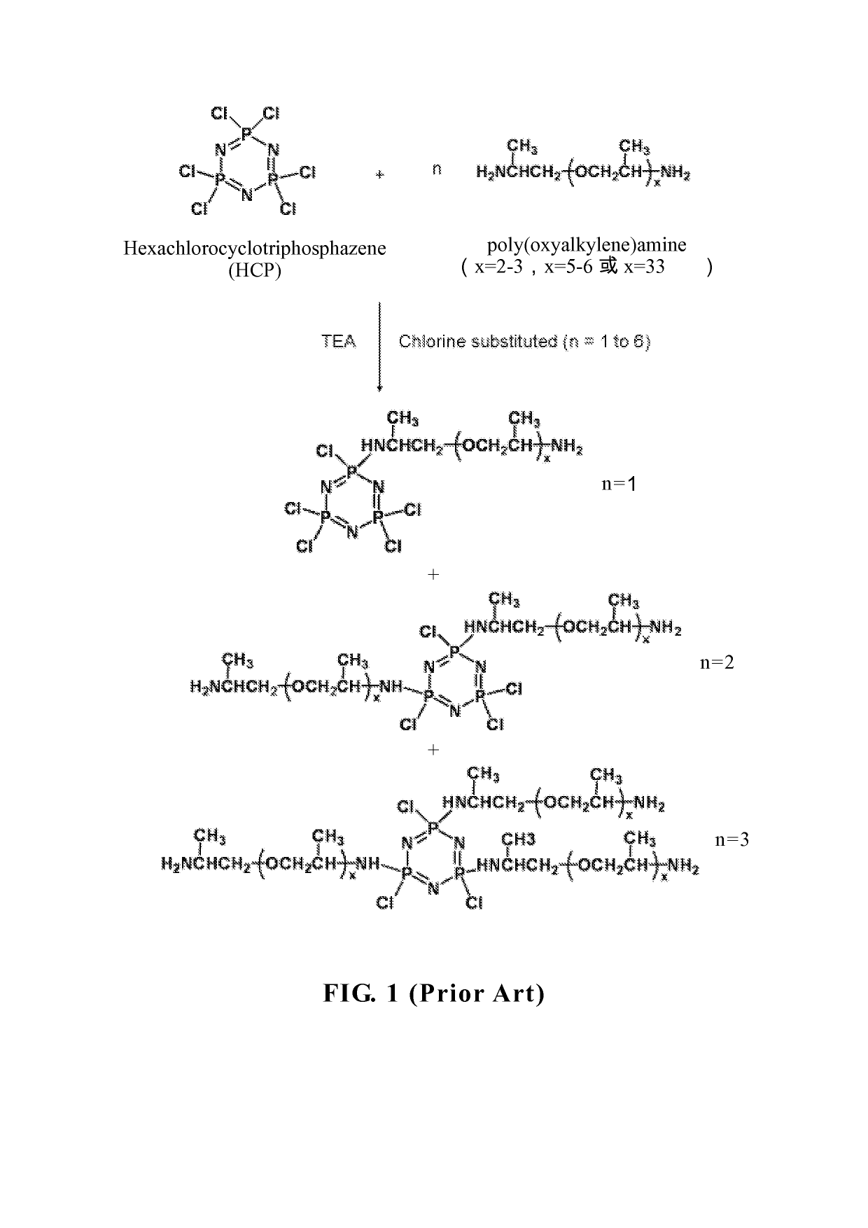

Tetrahydrofuran (THF, 40 g) and D400 (10 g, 25 mmole) were added in a three-necked bottle and uniformly mixed. HCP (7.24 g, 4.2 mmole, 20 wt % in THF) was slowly dropped into the above solution. Next, TEA (3.79 g) was slowly dropped into the three-necked bottle so that the molar ratio of HCP/D400/TEA was 1/6/9. The solution became white from transparency. The reaction was carried out in nitrogen gas, and controlled at 50° C. After 24 hours, the resultant salt was filtered with a filter paper and THF was removed by decompression rotary concentration to obtain the final product HCP-D400. FIG. 1 shows the synthesizing reaction of HCP and poly(oxyalkylene)amine.

### Step (b) Synthesizing the Flame Retardant (HCP-D400/NSP)

A diluted NSP solution (100 g) is prepared by adding water into a NSP solution (50 g, 10 wt % in water) in a beaker. The diluted NSP solution is then stirred at 25° C. for one hour. HCP-D400 (5 g) produced in step (a) is dissolved in isopropanol (20 g) which is then mixed in the diluted NSP solution to perform a reaction at 25° C. for 3 hours. The solution is then filtered and the product HCP-D400/NSP (weight ratio=5/5) is obtained.

### Step (c) Synthesizing the Resin Containing the Flame Retardant (HCP-D400/NSP/DGEBA)

BE188 (0.5 g), D400 (0.178 g) and HCP-D400/NSP (0.07 g) of step (b) were mixed with a homogenizer. The solution was poured in an alumina disk which was then placed in an oven for crosslinking. The crosslinking was performed at room temperature (1 hour), 80° C. (1 hour) and 120° C. (5 hours). The final product was BE188/NSP/HCP-D400, wherein the flame retardant, phosphorus and NSP are present in amounts of 10 wt %, 0.2 wt % and 5 wt %, respectively.

### Example 2

Repeat steps of Example 1, except that, in step (c), DGEBA (5 g), D400 (1.78 g) and HCP-D400/NSP (0.21 g) are added. The final product is HCP-D400/NSP/DGEBA, wherein the flame retardant and phosphorus are respectively present in amounts of 3 wt % and 0.06 wt %.

### Example 3

Repeat steps of Example 1, except that, in step (c), DGEBA (5 g), D400 (1.78 g) and HCP-D400/NSP (0.07 g) are added. The final product is HCP-D400/NSP/DGEBA wherein the flame retardant, phosphorus and NSP are present in amounts of 1.0 wt %, 0.02 wt % and 0.5 wt %, respectively.

### Example 4

Repeat steps of Example 1, except that, in step (b), HCP-D400 (1.43 g) is added. The final product is HCP-D400/NSP (3/7).

### Example 5

Repeat steps of Example 1, except that, in step (b), HCP-D400 (11.67 g) is added. The final product is HCP-D400/NSP (7/3).

### Example 6

Repeat steps of Example 1, except that, in step (b), HCP-D400 (0.56 g) is added. The final product is HCP-D400/NSP (1/9).

### Example 7

Repeat steps of Example 1, except that, in step (a), D400 is replaced with D2000 (10 g, 5 mmole), HCP (1.45 g, 0.83 mmole) and TEA (0.76 g, 7.52 mmole) are added. The molar ratio of HCP/D2000/TEA is 1/6/9. The final product is HCP-D2000/NSP.

### Comparative Example 1

### (a) Synthesizing Phosphorous Poly(Oxyalkylene)Amine Polymer

Tetrahydrofuran (THF, 40 g) and D400 (10 g, 25 mmole) were added in a three-necked bottle and uniformly mixed. HCP (7.24 g, 4.2 mmole, 20 wt % in THF) was slowly dropped into the above solution. Next, TEA (3.79 g) was slowly dropped into the three-necked bottle so that the molar ratio of HCP/D400/TEA was 1/6/9. The solution became white from transparency. The reaction was carried out in nitrogen gas, and controlled at 50° C. After 24 hours, the resultant salt was filtered with a filter paper and THF was removed by decompression rotary concentration to obtain the final product HCP-D400.

### Step (b) Synthesizing the Flame Retardant (HCP-D400/MMT)

Water was added into a beaker containing Na⁺-MMT (1 g, 1.2 meq.) to have a whole mass 100 g. The solution was then swollen at 80° C. for 1 hour. HCP-D400 (2.61 g, 3.6 meq.) from step (a) was mixed with HCl_{(aq)} (0.125 g, 1.2 meq.) at an equivalent ratio (H⁺/—NH₂=1/3) to acidify the end amino groups (—NH₂). Then the acidified HCP-D400 was added into the swollen MMT solution at an equivalent ratio (CEC/H⁺/—NH₂=1/1/3) to perform ionic exchanging reaction. The ionic exchanging reaction was controlled at 80° C. for 3 hours. The product HCP-D400/MMT (3/1) was precipitated and separated out from the solution.

### (c) Synthesizing the Resin Containing a Flame Retardant

HCP-D400/MMT (0.1 g) from step (b), D400 (1.667 g) and DGEBA (3.133 g) were mixed with a homogenizer. In the reactants, MMT had a concentration 5 wt %, and the equivalent ratio of DGEBA/D400 is 1/1. The solution was poured in an alumina disk which was then placed in an oven for crosslinking. The crosslinking was performed at room temperature (1 hour), 80° C. (1 hour) and 120° C. (5 hours). The final product was a nano-composite, HCP-D400/MMT/DGEBA, wherein phosphorus is present in an amount of 0.2 wt %.

### Comparative Example 2

Repeat steps of Comparative Example 1, except that, in step (a), MMT is present in an amount of 0.5 wt % (the theoretical value) and phosphorus is present in an amount of 0.02 wt %.

### Analysis and Tests of the Products

1. HCP-D400 produced by nucleophilic replacement reaction of HCP and D400 has a molecular weight about 1700 g/mol, the polydispersity index (PDI) of molecular weight was 2.49, and the titration value was 1.48 mequiv/g (theoretical value was 2.37 mequiv/g).
2. In the replacement reaction, more than one D400 replace plural chloral groups of HCP so that crosslinking and steric hindrance occur and the product HCP-D400 has a branch-like structure.
3. The flame retardant of HCP-POP and NSP can be dissolved in water, ethanol, butanol, PGMEA, toluene, etc.

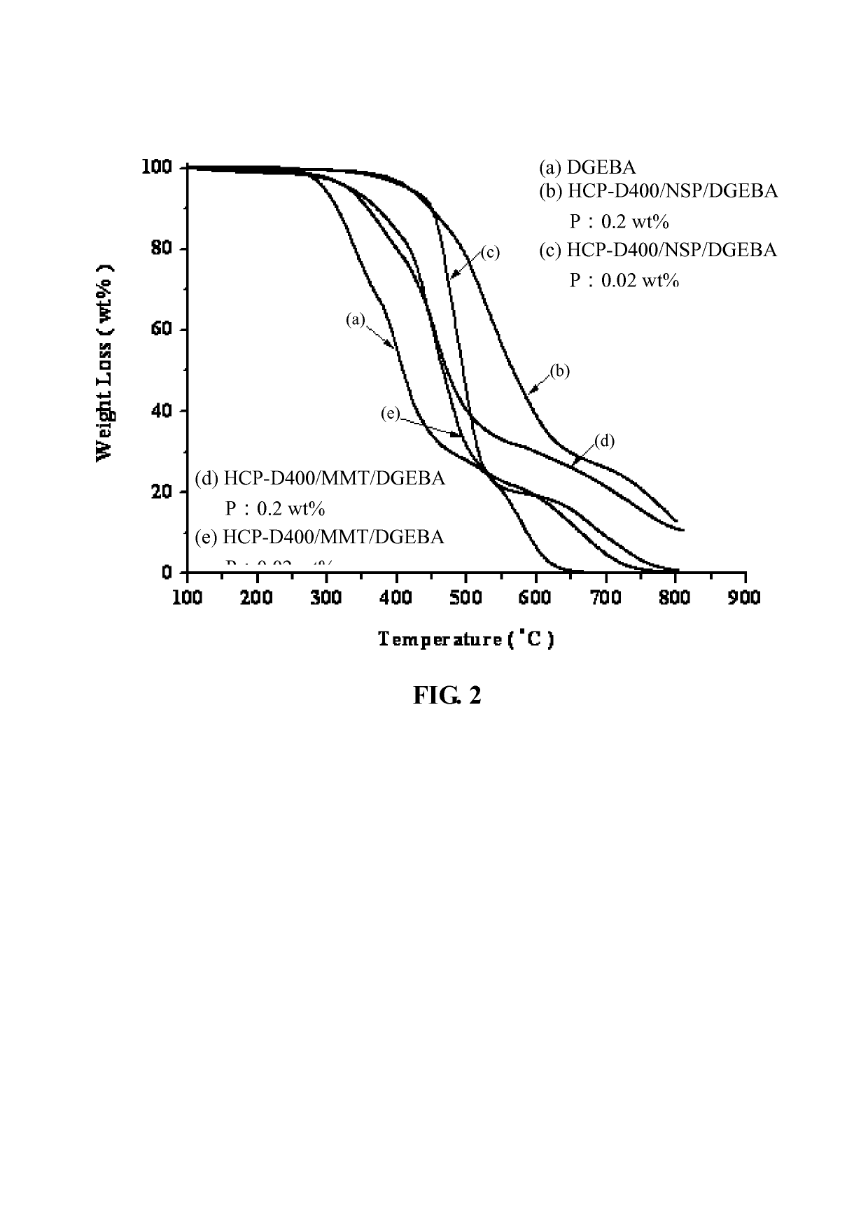

FIG. 2 shows char yields of HCP-D400/NSP/DGEBA and HCP-D400/MMT/DGEBA. For the epoxy containing the flame retardant HCP-D400/NSP, the char yield of thermal pyrolysis increases with contents of phosphorus. The reason is that phosphorus of the triphosphorus nitride transformed to the phosphoric acid protective layer in cracking, which blocked oxygen off and prevented cracking.

The pure epoxy film (DGEBA), the films (HCP-D400/NSP/DGEBA) of Examples 1 and 3 and the films (HCP-D400/MMT/DGEBA) of Comparative Examples 1-3 were used for TGA (thermal gravimetric analyses). Table 1 shows the results.

For the film including HCP-D400/NSP (1 wt %), T_{10 wt %} (10 wt % of loss at this temperature) increases by 90° C. and T_{85 wt %} (85 wt % of loss at this temperature) increases by 59° C. than those of the pure epoxy film. For the film including HCP-D400/NSP (10 wt %), T_{10 wt %} increases by 88° C. and T_{85 wt %} increases by 190° C. than those of the pure epoxy film. Such results indicate that nanosilicate platelets (NSP) can greatly improve the effect of the phosphorous flame retardant than montmorillonite (MMT).

TABLE 1

| Example/ | Content of the | Content of | | Thermal stability ^{d} | | |
|---|---|---|---|---|---|---|
| Comparative | flame retardant | NSP or MMT | phosphorus | T_{10 wt %} | T_{50 wt %} | T_{85 wt %} |
| Example | (wt %) ^{a} | (wt %) ^{b} | (wt %) ^{c} | (° C.) | (° C.) | (° C.) |
| Example 1 | HCP-D400/NSP (10) | 5.0 (NSP) | 0.20 | 448 | 568 | 788 |
| Example 3 | HCP-D400/NSP (1) | 0.5 (NSP) | 0.02 | 450 | 496 | 657 |
| Comparative | HCP-D400/MMT (10) | 5.0 (MMT) | 0.20 | 385 | 474 | 696 |
| Example 1 | | | | | | |
| Comparative | HCP-D400/MMT (1) | 0.5 (MMT) | 0.02 | 414 | 463 | 630 |
| Example 2 | | | | | | |
| DGEBA | 0 | 0 | 0 | 360 | 457 | 598 |

^{a} calculated based on MMT present in the flame retardant
^{b} based on TGA
^{c} calculated according to HCP-D400
^{d} weight loss, TGA, 100 to 800° C., 10° C./min

1. A method for producing a phosphorous flame retardant including NSP, comprising steps of:
(a) mixing hexachlorocyclotriphosphazene (HCP), alkaline and poly(oxyalkylene)amine in a first solvent to perform a replacement reaction so that at least one chlorine of HCP is replaced with poly(oxyalkylene)amine to form HCP-poly(oxyalkylene)amine, wherein poly(oxyalkylene)amine includes at least two end amino groups (—NH₂), the molar ratio of HCP to poly(oxyalkylene)amine ranges from 1/1 to 1/12, and the replacement reaction is performed at a temperature from 35° C. to 85° C.;
(b) mixing the HCP-poly(oxyalkylene)amine of step (a) and nanosilicate platelets (NSP) in a second solvent to produce the phosphorous flame retardant including NSP (HCP-poly(oxyalkylene)amine/NSP), wherein the NSP is in the form of individual platelets or layers exfoliated from layered clay and the weight ratio of HCP-poly(oxyalkylene)amine to NSP ranges from 1/20 to 10/1.

2. The method of claim 1, wherein the poly(oxyalkylene)amine of step (a) is previously mixed with the first solvent, then HCP dissolved in the first solvent is slowly dropped thereinto, and finally the alkaline is slowly dropped thereinto.

3. The method of claim 1, wherein the first solvent of the step (a) is tetrahydrofuran (THF).

4. The method of claim 1, wherein poly(oxyalkylene)amine of the step (a) is poly(oxyalkylene)diamine having a molecular weight from 200 to 2500.

5. The method of claim 1, wherein the second solvent of step (b) is alcohol or aldehyde.

6. The method of claim 1, further comprising a step after step (b):
(c) crosslinking the phosphorous flame retardant including NSP with epoxy at 10 to 200° C., wherein the phosphorous flame retardant including NSP in the reaction mixture is present in an amount of 0.1 to 50 wt %.

7. The method of claim 6, wherein the epoxy is DGEBA (diglycidyl ether of bisphenol A).

8. The method of claim 6, wherein the phosphorous flame retardant including NSP in the reaction mixture is present in an amount of 0.2 to 20 wt %.

9. A phosphorous flame retardant including NSP, comprising HCP-poly(oxyalkylene)amine and nanosilicate platelets (NSP) in a weight ratio of 1/20 to 10/1; wherein HCP-poly(oxyalkylene)amine is hexachlorocyclotriphosphazene (HCP) having at least one chlorine substituted with poly(oxyalkylene)amine which includes at least two end amino groups (—NH₂), and the NSP is in the form of individual platelets or layers exfoliated from layered clay.

10. A flame retardant resin, comprising the phosphorous NSP flame retardant of claim 10 and epoxy, wherein the end amino groups (—NH₂) of poly(oxyalkylene)amine crosslink with epoxy, and the phosphorous NSP flame retardant is present in an amount of 0.1 to 50 wt % in the flame retardant resin.
